(19) United States
(12) Patent Application Publication
(10) Pub. No.: US 2020/0107654 A1
(43) Pub. Date: Apr. 9, 2020

(54) Famous painting spotlight

(71) Applicant: Yanghua Wu, Xiamen City (CN)

(72) Inventor: Yanghua Wu, Xiamen City (CN)

(21) Appl. No.: 16/705,210

(22) Filed: Dec. 5, 2019

(30) Foreign Application Priority Data
Apr. 30, 2019 (CN) 2019103611086

(51) Int. Cl. A47F 7/14; F21V 8/00; A47F 7/024

(52) U.S. Cl. CPC A47F 7/146; G02B 6/0035; A47F 7/0246; G02B 6/009

(57) ABSTRACT

The invention discloses a famous painting spotlight, which comprises a wall, a driving cavity is provided in the wall, a driving cavity is provided at the right end of the driving cavity, and a lateral chute communicating with the external space is provided in the driving cavity. The lower end wall of the lateral chute is provided with a display slot that communicates with the external space. A connection chute is connected between the display slot and the driving cavity. The motor is first turned on to drive the motor shaft to rotate and the first thread block When the second thread block is moved to the right and the lower pressing block is moved to the right, the long plate and the lock block are pushed down by the trapezoidal block, so that the lock block is released from the lock groove. This device can photograph famous paintings in the exhibition. The bright function can better perform the exhibition. At the same time, the device also has certain protection functions. After the exhibition is finished, the famous paintings can be locked in the wall to ensure the safety of the famous paintings.

### CROSS-REFERENCES TO RELATED APPLICATIONS

The present application claims priority from Chinese application No. 2019103611086 filed on Apr. 30, 2019 which is hereby incorporated by reference in its entirety.

### FIELD OF TECHNOLOGY

The invention relates to the field of lights, and in particular relates to A famous painting spotlight.

### TECHNICAL FIELD

In the exhibition of famous paintings, in order to show the details of the paintings, spotlights will be put on the famous paintings. However, traditional lamps can only show the details of the paintings. Good protection.

### CONTENT OF THE INVENTION

The object of the present invention is to provide a famous painting spotlight to solve the problems raised in the background art mentioned above.

To achieve the above object, the present invention provides the following technical solution: A famous painting spotlight includes a wall, a driving cavity is provided in the wall, a driving cavity is provided at the right end of the driving cavity, and a driving cavity is provided in the driving cavity. A lateral chute communicating with the external space, a lower end wall of the lateral chute is provided with a display groove communicating with the external space, a connection chute is communicated between the display groove and the driving cavity, and a right end wall of the driving cavity A motor is provided. The motor is provided with a motor shaft. The right end of the motor shaft is rotatably connected to the right end wall of the linkage cavity. The left end of the motor shaft is screw-connected with a first thread block and a second thread block, respectively. The first thread block and the second thread block are slidably connected to the lateral chute, a driving plate is fixed on the lower end surface of the first thread block, and the left end surface of the second thread block is symmetrically fixed up and down. A small block is provided, and a concave block is slidably connected to the small block. A small spring is connected to each of the concave block and the small block. A rotating shaft is rotatably connected to the concave block, and a fixed shaft is fixed on the rotating shaft. A protection plate with a lock on the lower end surface of the protection plate Slot, the right end face of the protection plate is fixed with three spotlights, the left end face of the protection plate is fixed with a second energizing head, and the upper end face of the lateral slide groove is fixed with a first energizing head. When the first energizing head is connected with the second energizing head, the spotlight emits light, and the left and right end walls of the linkage cavity are rotatably connected with a penetrating shaft, and the penetrating shaft is symmetrically fixed to the motor shaft. There is a pulley, and a belt is connected between the pulleys. The left end of the through shaft extends to the left through the left end wall of the linkage cavity into the drive cavity and is rotatably connected to the right end wall of the drive cavity. The left end of the penetrating shaft is screw-connected with a third thread block slidingly connected to the connection chute, the connection chute is opposite to the thread of the motor shaft, and the display slot is provided with a display device for placing famous paintings. An unlocking device for protecting the famous painting is also provided in the driving cavity and the linkage cavity.

Preferably, the display device includes a picture frame slidingly installed in the display slot, and a glass is provided in the picture frame, and the inside of the picture frame can be observed through the glass, and the picture frame and the A pushing spring is symmetrically connected up and down between the display grooves, and the third thread block can push the picture frame.

Preferably, the unlocking device includes a long plate slidably installed in the driving cavity, and an upper end surface of the long plate is fixedly provided with a trapezoidal block slidably connected to the lower pressing block, and a right end surface of the trapezoidal block A limiting chute is provided, a limiting mechanism is arranged in the limiting chute, a connecting spring is symmetrically connected to the lower end face of the long plate, and an upper end wall of the driving cavity is provided with a small hole communicating with the display slot. A locking block which can be slidably connected to the lock groove is fixed on the upper end surface of the long plate, and a limiting card slot is connected between the driving cavity and the linking cavity, and an upper end wall of the limiting card slot. A moving chute is provided, and a long slide bar is slidably connected to the limiting card slot. A moving mechanism that is slidably connected to the moving chute is fixed on the upper end surface of the long slide bar. The limiting card slot is slidably connected, and a push block is fixed at the right end of the long slide bar. A rope groove is connected between the linkage cavity and the drive cavity, and the push block and the lower pressing block are connected. Connected with rope.

In summary, the present invention has the beneficial effects that the device can illuminate the famous paintings in the art exhibition, which can perform the exhibition better. At the same time, the device also has certain protection functions. Locked in the wall to ensure the safety of famous paintings.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those skilled in the art, other drawings can be obtained based on these drawings without paying creative labor.

FIG. 1 is a schematic front view of a famous full-cut spotlight of the present invention;

FIG. 2 is a partially enlarged view of A in FIG. 1 of the present invention;

FIG. 3 is a partially enlarged view of a portion B in FIG. 1 of the present invention;

FIG. 4 is a partial enlarged view of the position C in FIG. 1 of the present invention;

FIG. 5 is a sectional view taken along the D-D direction in FIG. 4 of the present invention.

### DETAILED DESCRIPTION OF THE INVENTION

All features disclosed in this specification, or all disclosed methods or steps, other than mutually exclusive features and/or steps, may be combined in any manner.

Any feature disclosed in this specification (including any additional claims, abstract, and drawings), unless specifically stated, may be replaced by other equivalent or similar purpose alternative features. That is, unless specifically stated, each feature is just one example of a series of equivalent or similar features.

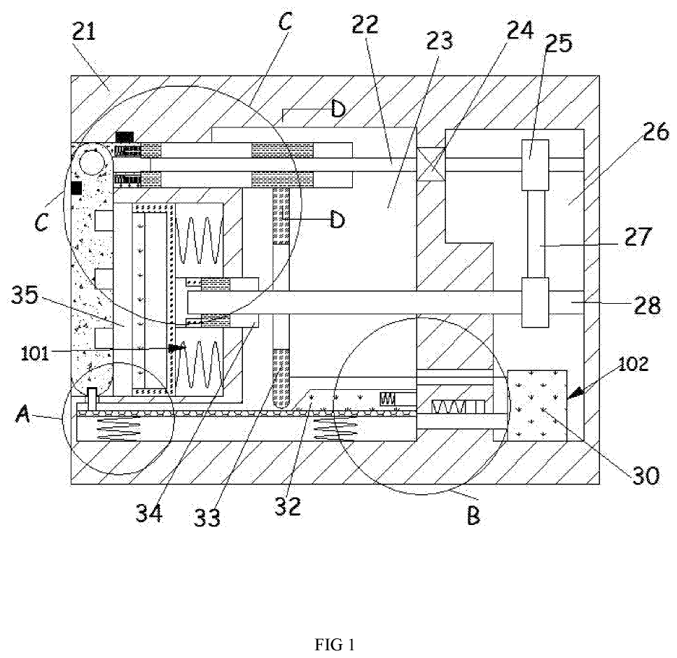

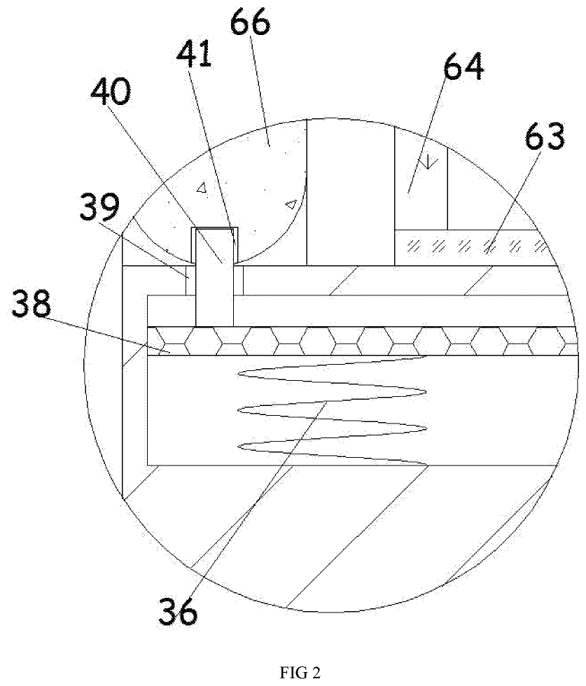

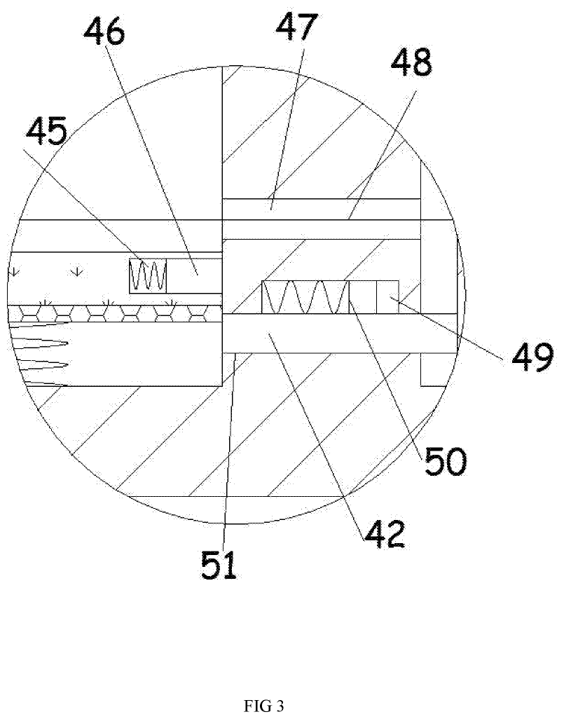

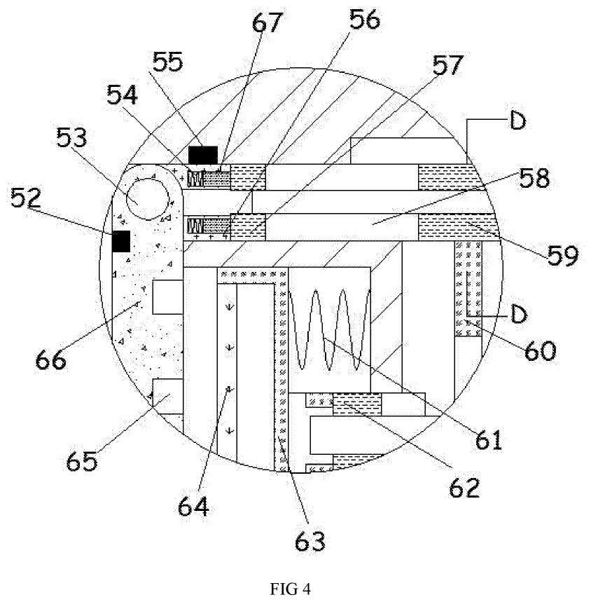

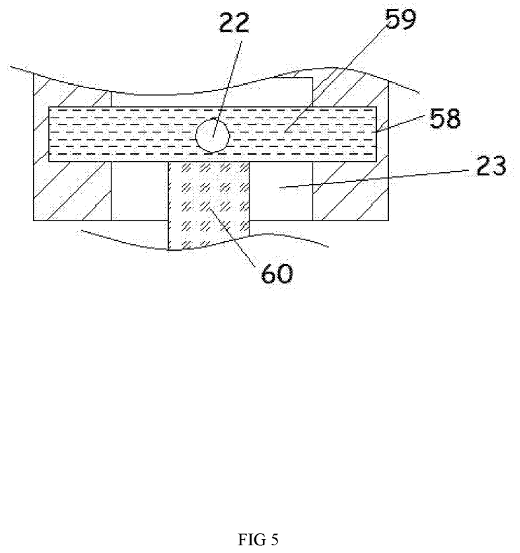

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1-5.

An embodiment of the present invention provides a famous painting spotlight, which includes a wall 21, a driving cavity 23 is provided in the wall 21, and a linking cavity 26 is provided at the right end of the driving cavity. The driving cavity 23 is provided with a lateral slide groove 58 communicating with the external space, and a lower end wall of the lateral sliding groove 58 is provided with a display groove 35 communicating with the external space. The display groove 35 and the driving cavity 23. A connecting chute 34 is communicated therebetween. A right end wall of the driving cavity 23 is provided with a motor 24, and a motor shaft 22 is provided in the motor 24. The right end of the motor shaft 22 and the right end wall of the linking cavity 26. Rotating connection, the left end of the motor shaft 22 is threaded with a first thread block 59 and a second thread block 57 respectively, and the first thread block 59 and the second thread block 57 are slidably connected with the lateral slide groove 58. A driving plate 60 is fixed on the lower end surface of the first thread block 59, and a small block 67 is symmetrically fixed on the left end surface of the second thread block 57. A recess 56 is slidably connected to the small block 67. A small spring 54 is connected to the concave block 56 and the small block 67 respectively, and a rotating shaft 53 is rotatably connected to the concave block 56. A protection plate 66 is fixed on the shaft 53, a locking groove 41 is provided on a lower end surface of the protection plate 66, three spotlights 65 are fixed on a right end surface of the protection plate 66, and a left end surface of the protection plate 66 is fixed. A second energizing head 52 is provided, and a first energizing head 55 is fixed on the upper end surface of the lateral sliding groove 58. When the first energizing head 55 is connected to the second energizing head 52, the spotlight 65. A bright light is emitted, and a penetrating shaft 28 is rotatably connected to the left and right end walls of the interlocking cavity 26, and a pulley 25 is symmetrically fixed to the penetrating shaft 28 and the motor shaft 22. A belt 27 is connected between the pulleys 25. The left end of the through shaft 28 extends to the left through the left end wall of the linkage cavity 26 into the driving cavity 23 and is rotatably connected to the right end wall of the driving cavity 23, and the left end of the through shaft 28 is threadedly connected There is a third thread block 62 slidingly connected to the connection chute 34. The connection chute 34 is opposite to the thread of the motor shaft 22. The display groove 35 is provided with a display device 101 for placing famous paintings. The driving cavity 23 and the linkage cavity 26 are further provided with an unlocking device 102 for protecting the famous paintings.

The display device 101 includes a picture frame 63 slidably installed in the display slot 35, and a glass 64 is provided in the picture frame 63. The inside of the picture frame 63 can be viewed through the glass 64. A pushing spring 61 is symmetrically connected up and down between the picture frame 63 and the display slot 35. The third thread block 62 can push the picture frame 63. When the third thread block 62 moves to the left, The picture frame 63 is pushed to the left, and its role is to push out famous paintings for the convenience of exhibition.

The unlocking device 102 includes a long plate 38 slidably installed in the driving cavity 23, and an upper end surface of the long plate 38 is fixed with a trapezoidal block 32 which can be slidably connected with the lower pressing block 33. The trapezoidal block The right end face of 32 is provided with a limit chute 45. A limit stop mechanism 46 is provided in the limit chute 45. The lower end face of the long plate 38 is symmetrically connected to the left and right connecting springs 36. The upper end wall of the drive cavity 23 is provided There is a small hole 39 communicating with the display slot 35, and an upper end surface of the long plate 38 is fixed with a lock block 40 which can be slidably connected with the lock slot 41, the driving cavity 23 and the linkage cavity 26. A limiting slot 51 is connected between the slots. An upper end wall of the limiting slot 51 is provided with a moving sliding slot 49. A long sliding rod 42 is slidably connected to the limiting slot 51. A moving mechanism 50 slidingly connected to the moving chute 49 is fixed on the end surface, the limiting mechanism 46 can be slidably connected to the limiting card slot 51, and a pushing block 30 is fixed to the right end of the long sliding rod 42. A rope groove 47 is connected between the linkage cavity 26 and the driving cavity 23, and a rope 48 is connected between the pushing block 30 and the lower pressing block 33. When 33 moves to the right, the long plate 38 and the lock block 40 are pushed down by the trapezoidal block 32, so that the lock block 40 is disengaged from the lock groove 41. During this period, the The moving mechanism 50 will drive the long slide bar 42 and the pushing block 30 to move to the right, and the limit mechanism 46 will also be locked into the limit card slot 51 to complete unlocking. Its role is to It can provide a safe environment for famous paintings.

When in use, first turn on the motor 24 to drive the motor shaft 22 to move the first thread block 59 and the second thread block 57 to the right. When the lower pressing block 33 is moved to the right, the long plate 38 is moved through the trapezoid block 32. Push down with the lock block 40, so that the lock block 40 is released from the lock groove 41. During this period, the moving mechanism 50 will drive the long slide bar 42 and the push block 30 to move to the right, and the limit mechanism 46 will also snap into the limit card In the groove 51, the small spring 54 will pull the recess 56 to the right, the rotation shaft 53 will drive the protection plate 66 to rotate, and the second energizing head 52 also enters the lateral sliding groove 58. The first energizing head 55 and the second energizing head When 52 is turned on, the spotlight 65 emits light, and the pulley 25 drives the penetrating shaft 28 to rotate, thereby driving the third thread block 62 to move to the left, thereby pushing the picture frame 63 to the left, and the spotlight 65 performs the picture in the picture frame 63. Illuminated, when it needs to be closed, the motor 24 is reversed, the first threaded block 59 and the second threaded block 57 move to the left, and the protection plate 66 also returns to the position. Finally, the block 30 is pushed to move the long slide bar 42 to the leftmost end. At that time, the limit chute 45 will be pushed into the limit chute 45. The lock block 40 is reset, and the protection plate 66 can be locked.

The beneficial effect of the present invention is that the device can illuminate the famous paintings in the art exhibition and can perform the exhibition better. At the same time, the device also has certain protection functions. After the exhibition, the famous paintings can be locked in the wall To ensure the safety of famous paintings.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A famous painting spotlight includes a wall, characterized in that: a driving cavity is provided in the wall, a driving cavity is provided at the right end of the driving cavity, and a lateral chute communicating with the external space is provided in the driving cavity The lower end wall of the lateral chute is provided with a display slot communicating with the external space, a connection chute is communicated between the display slot and the driving cavity, and a right end wall of the driving cavity is provided with a motor. A motor shaft is provided in the motor. The right end of the motor shaft is rotatably connected to the right end wall of the linkage cavity. The left end of the motor shaft is screw-connected with a first thread block and a second thread block, respectively. The block and the second thread block are slidably connected to the lateral chute. A driving plate is fixed on the lower end surface of the first thread block, and small blocks are fixed on the left end surface of the second thread block symmetrically. A concave block is slidably connected to the small block, and a small spring is connected to the small block and the small block, respectively. A rotating shaft is rotatably connected to the concave block, and a protective plate is fixed on the rotating shaft. The lower end face of the board is provided with a lock groove, and the right end face of the protective plate There are three spotlights, a second energizing head is fixed on the left end surface of the protective plate, and a first energizing head is fixed on the upper end surface of the transverse chute. When the head is turned on, the spotlight emits bright light, and the left and right end walls of the linkage cavity are rotatably connected with a penetrating shaft, and the penetrating shaft and the motor shaft are symmetrically fixed with a pulley, and the pulley is connected with The left end of the through shaft extends to the left through the left end wall of the linkage cavity into the driving cavity and is rotatably connected to the right end wall of the driving cavity. The third thread block for sliding connection of the connection chute, the connection chute is opposite to the thread of the motor shaft, the display slot is provided with a display device for placing famous paintings, the driving cavity and the linkage cavity There is also an unlocking device for protecting the famous painting.

2. The famous painting spotlight according to claim 1, wherein the display device comprises a picture frame slidingly installed in the display slot, and a glass is arranged in the picture frame, and the glass can be viewed through the glass. To the inside of the picture frame, a push spring is symmetrically connected up and down between the picture frame and the display slot, and the third thread block can push the picture frame.

3. The famous spotlight according to claim 1, wherein the unlocking device comprises a long plate slidably installed in the driving cavity, and an upper end surface of the long plate is fixedly provided with the lower plate and can be pressed with the lower plate. A trapezoidal block slidably connected to the block, a right end surface of the trapezoidal block is provided with a limit chute, a limit mechanism is provided in the limit chute, a lower end of the long plate is symmetrically connected with a connection spring, and the driving cavity. The upper end wall is provided with a small hole communicating with the display slot, the upper end surface of the long plate is fixedly provided with a lock block which can be slidably connected with the lock slot, and the driving cavity is connected with the linkage cavity. A limit slot, the upper end wall of the limit slot is provided with a moving chute, and a long slide bar is slidably connected to the limit slot, and the upper end surface of the long slide bar is fixed to the moving chute. A slidingly connected moving mechanism, the limit mechanism can be slidably connected to the limit card slot, a push block is fixed at the right end of the long slide bar, and a rope is connected between the linkage cavity and the drive cavity. A groove is connected between the pushing block and the lower pressing block.
